(19) United States
(12) Patent Application Publication
(10) Pub. No.: US 2023/0357030 A1
(43) Pub. Date: Nov. 9, 2023

(54) SYNTHESIS OF ALUMINUM-CONTAINING CIT-13 AND CIT-15 MOLECULAR SIEVES

(71) Applicant: CHEVRON U.S.A. INC., San Ramon, CA (US)

(72) Inventor: Christopher Michael LEW, Alameda, CA (US)

(21) Appl. No.: 17/739,301

(22) Filed: May 9, 2022

(51) Int. Cl. C01B 39/06

(52) U.S. Cl. CPC C01B 39/06

(57) ABSTRACT

Methods are provided for preparing molecular sieves CIT-13 and CIT-15 having aluminum incorporated into the framework structures.

### FIELD

The present disclosure related to methods of preparation of aluminogermanosilicate molecular sieves CIT-13 and CIT-15.

### BACKGROUND

Molecular sieves are a commercially important class of materials that have distinct crystal structures with defined pore structures that are shown by distinct X-ray diffraction (XRD) patterns and have specific chemical compositions.

Molecular sieves are classified by the Structure Commission of the International Zeolite Association according to the rules of the IUPAC Commission on Zeolite Nomenclature. According to this classification, framework type zeolites and other crystalline microporous crystalline materials, for which a structure has been established, are assigned a unique three-letter code and are described, for example, in the “Atlas of Zeolite Framework Types” (Elsevier, Sixth Revised Edition, 2007).

*CTH framework type molecular sieves are disordered materials having a two-dimensional pore system possessing pores that are bounded by 14- and 10-membered rings. Examples of *CTH framework type molecular sieves include germanosilicates CIT-13, NUD-2 and SAZ-1. Extra-large-pore molecular sieves such as CIT-13 have attracted interest because of their ability to catalyze reactions with larger reactant and product molecules.

Germanosilicate CIT-13 is composed of Si-rich cfi-layers bridged by two-dimensional arrays of Ge-rich double-4-ring (d4r) units. The lability of the Ge-rich d4r units in the CIT-13 germanosilicates offers a rich chemistry, which differs depending on the germanium content of the CIT-13 compositions. U.S. Patent Appl. Pub. No. 2017/0252729 discloses the topotactic transformation of germanosilicate CIT-13 into CIT-15, a molecular sieve material having a one-dimensional pore system possessing 10-membered rings pores. Molecular sieves with one-dimensional 10-membered ring pores have shown attractive properties as catalysts or catalyst components for the dewaxing of hydrocarbon feedstocks.

Germanosilicate molecular sieves such as CIT-13 and CIT-15, however, are not sufficiently catalytically active to be practicable for certain hydrocarbon conversion processes. One important synthetic challenge is to incorporate catalytically active sites, such as aluminum atoms, into these molecular sieve frameworks.

Accordingly, methods are provided herein for the introduction of aluminum into the frameworks of CIT-13 and CIT-15.

### SUMMARY

In one aspect, there is provided a method for synthesizing aluminogermanosilicate molecular sieve CIT-13, the method comprising: (1) preparing a reaction mixture comprising: (a) a source of aluminum; (b) a source of silicon; (c) a source of germanium; (d) an organic structure directing agent (Q) comprising one or more of 1,2-dimethyl-3-(3-methylbenzyl)imidazolium cations, 1-methyl-3-(3-methylbenzyl)-imidazolium cations, 1,2-dimethyl-3-(3,5-dimethylbenzyl)imidazolium cations, and 1-methyl-3-(3,5-dimethylbenzyl)-imidazolium cations; (e) a source of fluoride ions; (f) water; and (g) seed material, wherein the seed material comprises a crystalline molecular sieve of *CTH framework type; and (2) subjecting the reaction mixture to crystallization conditions sufficient to form crystals of the aluminogermanosilicate molecular sieve.

In another aspect, there is provided a method for synthesizing aluminogermanosilicate molecular sieve CIT-15, the method comprising the steps of: (1) preparing a reaction mixture comprising: (a) a source of aluminum; (b) a source of silicon; (c) a source of germanium; (d) an organic structure directing agent (Q) comprising one or more of 1,2-dimethyl-3-(3-methylbenzyl)imidazolium cations, 1-methyl-3-(3-methylbenzyl)-imidazolium cations, 1,2-dimethyl-3-(3,5-dimethylbenzyl)imidazolium cations, and 1-methyl-3-(3,5-dimethylbenzyl)-imidazolium cations; (e) a source of fluoride ions; (f) water; and (g) seed material, wherein the seed material comprises a crystalline molecular sieve of *CTH framework type; (2) subjecting the reaction mixture to crystallization conditions sufficient to form crystals of the aluminogermanosilicate molecular sieve; (3) recovering and calcining the product of step (2) to obtain a calcined aluminogermanosilicate CIT-13 molecular sieve; (4) treating the calcined aluminogermanosilicate CIT-13 molecular sieve with water under conditions sufficient to degermanate at least a portion of the calcined aluminogermanosilicate CIT-13 molecular sieve to provide a phyllosilicate comprising delaminated cfi-layers; and (5) recovering and calcining the phyllosilicate under conditions sufficient to convert the phyllosilicate to an aluminogermanosilicate CIT-15 molecular sieve.

### BRIEF DESCRIPTION OF THE DRAWINGS

FIG. 1 is a powder X-ray diffraction (XRD) pattern of a sample of Al-CIT-13 as prepared in Example 1.

FIG. 2 is a Scanning Electron Microscopy (SEM) image of a sample of Al-CIT-13 as prepared in Example 1.

FIG. 3 is a powder XRD pattern of a sample of Al-CIT-15 as prepared in Example 5.

FIG. 4 is a SEM image of a sample of Al-CIT-15 as prepared in Example 5.

FIG. 5 is a graph of conversion or yield versus temperature for n-decane hydroconversion over a Pd-exchanged Al-CIT-15 catalyst.

FIG. 6 is a graph of yield versus conversion for n-decane hydroconversion over a Pd-exchanged Al-CIT-15 catalyst.

FIG. 7 is a graph illustrating iso-C10 product distribution for n-decane hydroconversion over a Pd-exchanged Al-CIT-15 catalyst.

### DETAILED DESCRIPTION

### Glossary

The term “aluminogermanosilicate” means a zeolite having a framework constructed of alumina, germania and silica (i.e., repeating AlO4, GeO4 and SiO4 tetrahedral units).

The term “framework type” is used in the sense described in the “Atlas of Zeolite Framework Types,” by Ch. Baerlocher, L. B. McCusker, and D. H. Olson (Elsevier, Sixth Revised Edition, 2007).

The term “sol” means a dispersion of colloidal (i.e., particle diameter less than one micrometer) solid particles within a liquid.

The term “SiO₂/Al₂O₃ molar ratio” may be abbreviated as “SAR”.

### Synthesis of Aluminogermanosilicate CIT-13 (Al-CIT-13)

Aluminogermanosilicate molecular sieve CIT-13 can be synthesized by: (1) preparing a reaction mixture comprising (a) a source of aluminum; (b) a source of silicon; (c) a source of germanium; (d) an organic structure directing agent comprising one or more of 1,2-dimethyl-3-(3-methylbenzyl)imidazolium cations, 1-methyl-3-(3-methylbenzyl)-imidazolium cations, 1,2-dimethyl-3-(3,5-dimethylbenzyl)imidazolium cations, and 1-methyl-3-(3,5-dimethylbenzyl)-imidazolium cations; (e) a source of fluoride ions; (f) water; and (g) seed material, wherein the seed material comprises a crystalline molecular sieve of *CTH framework topology; and (2) subjecting the reaction mixture to crystallization conditions sufficient to form crystals of the aluminogermnosilicate molecular sieve.

The reaction mixture can have a composition, in terms of molar ratios, within the ranges set forth in Table 1:

TABLE 1

| Reactants | Broadest | Typical |
|---|---|---|
| (SiO₂ + GeO₂)/Al₂O₃ | 35 to 500 | 50 to 165 |
| Q/(SiO₂ + GeO₂) | 0.20 to 0.75 | 0.25 to 0.65 |
| F/(SiO₂ + GeO₂) | 0.20 to 0.75 | 0.25 to 0.65 |
| H₂O/(SiO₂ + GeO₂) | 5 to 20 | 5 to 15 |

Suitable sources of aluminum include hydrated alumina, aluminum hydroxide, alkali metal aluminates, aluminum alkoxides (e.g., aluminum isopropoxide), and water-soluble aluminum salts (e.g., aluminum nitrate).

Suitable sources of silicon include colloidal silica, fumed silica, alkali metal silicates (e.g., sodium silicate), tetraalkyl orthosilicates, (e.g., tetraethyl orthosilicate), and precipitated silica.

Combined aluminum and silicon sources can also be used, such as aluminosilicate sols. Suitable aluminosilicate sols can be obtained from NALCO Water, an Ecolab Company. The aluminosilicate sol may be used as the sole or predominant source of silicon and aluminum. The term “predominant” means greater than 50 mole % (e.g., greater than 75 mole %, or greater than 90 mole %).

Suitable germanium sources include germanium oxide, germanium nitrate and tetraalkoxy germanium compounds (e.g., tetraethoxygermanium).

In some aspects, silicon oxide and germanium oxide are present in the reaction mixture in a molar ratio of SiO₂/GeO₂ in a range of from 1 to 10 (e.g., 3 to 8).

The organic structure directing agent (Q) comprises one or more of 1,2-dimethyl-3-(3-methylbenzyl)imidazolium cations, 1-methyl-3-(3-methylbenzyl)-imidazolium cations, 1,2-dimethyl-3-(3,5-dimethylbenzyl)imidazolium cations, and 1-methyl-3-(3,5-dimethylbenzyl)-imidazolium cations, represented by the following structures (1), (2), (3), and (4), respectively:

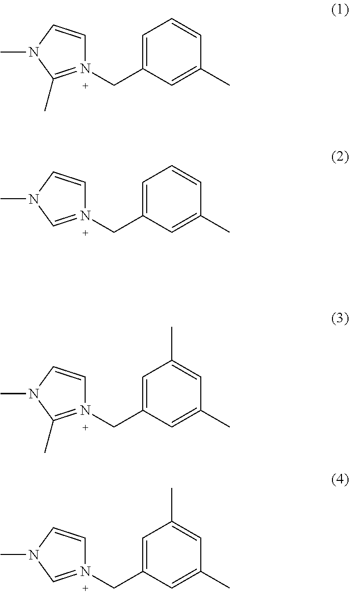

Suitable sources of Q include the hydroxides, chlorides, bromides, and/or other salts of the relevant quaternary ammonium compound(s).

Suitable sources of fluoride ions include HF, NH₄F, and NH₄HF₂.

The seed material can comprise any molecular sieve material having a *CTH-type framework structure. The seed material can comprise a molecular sieve selected from the group consisting of CIT-13, NUD-2, SAZ-1, and any combination thereof. In some aspects, the seed material comprises CIT-13. Seed material can be added in an amount of from 0.1 to 10% of the weight of silica used in the reaction mixture.

The reaction mixture can be prepared by any conceivable means, wherein mixing by agitation is preferred, preferably by means of stirring. The reaction mixture can be prepared in batch, continuous, or semi-continuous mode.

The reaction mixture can be in the form of a solution, a colloidal dispersion, gel, or paste, with a gel being preferred.

Crystallization of the desired molecular sieve from the reaction mixture may be carried out under static or stirred conditions in a suitable reactor vessel, such as for example, polypropylene jars or Teflon lined or stainless steel autoclaves placed in a convection oven maintained at a temperature of from 100° C. to 200° C. for a period of time sufficient for crystallization to occur (e.g., from about 1 day to 30 days, or 1 day to 15 days). Crystallization is usually conducted under autogenous pressure.

Once the desired molecular sieve crystals have formed, the solid product can be separated from the reaction mixture by standard mechanical separation techniques such as centrifugation or filtration. The recovered crystals are water-washed and then dried, for several seconds to a few minutes (e.g., 5 seconds to 10 minutes for flash drying) or several hours (e.g., 4 hours to 24 hours for oven drying at 75° C. to 150° C.), to obtain the as-synthesized molecular sieve crystals. The drying step can be performed under vacuum or at atmospheric pressure.

As a result of the crystallization process, the recovered as-synthesized crystalline molecular sieve product contains within its pore structure at least a portion of the organic structure directing agent used in the synthesis.

The organic structure directing agent can be removed by calcination, where the as-synthesized molecular sieve is heated under an oxidizing atmosphere, such as air or oxygen, a neutral atmosphere, such as nitrogen or other inert gas, or a reducing atmosphere, such as hydrogen. The atmosphere can be dry or can include water.

The temperatures used in calcination depend upon the components in the material to be calcined and generally are from 400° C. to 900° C. for approximately 1 to 8 hours. In some cases, calcination can be performed up to a temperature of 1200° C. In applications involving the methods described herein, calcinations are generally performed at temperatures from 400° C. to 700° C. for approximately 1 to 8 hours, preferably at temperatures from 400° C. to 650° C. for approximately 1 to 4 hours.

In its as-synthesized or calcined form, Al-CIT-13 can have a (SiO₂+GeO₂)/Al₂O₃ molar ratio in a range of from 35 to 500 (e.g., 35 to 250, or 35 to 150, or 50 to 500, or 50 to 250, or 50 to 150). In some aspects, the SiO₂/GeO₂ molar ratio can be in a range of from 3.8 to 6.0 (e.g., 3.8 to 5.4, or 3.8 to 5.0, or 4.0 to 6.0, or 4.0 to 5.0)

As taught by U.S. Patent Appl. Pub. No. 2016/0346771, molecular sieve CIT-13 may be described as having a powder XRD pattern exhibiting at least five of the characteristic peaks at 6.45 (±0.2), 7.18 (±0.2), 12.85 (±0.2), 18.26 (±0.2), 18.36 (±0.2), 18.63 (±0.2), 20.78 (±0.2), 21.55 (±0.2), 23.36 (±0.2), 24.55 (±0.2), 26.01 (±0.2), and 26.68 (±0.2) degrees 2-theta. In some aspects, the molecular sieve may exhibit six, seven, eight, nine, or ten of these characteristic peaks. The powder XRD patterns presented were determined by standard techniques. The radiation was the K-alpha/doublet of copper. Minor variations in the diffraction pattern values in the tables or the figures can also result from variations in the organic compound used in the preparation and from variations in the silica-to-alumina mole ratio from sample to sample. Notwithstanding these minor perturbations, the basic crystal structures for the as-prepared condition and the calcined condition remain substantially unchanged.

### Synthesis of Aluminogermanosilicate CIT-15 (Al-CIT-15)

If desired, calcined Al-CIT-13, prepared as described herein, can be converted to an aluminogermanosilicate CIT-15 molecular sieve (Al-CIT-15).

Al-CIT-13 molecular sieve may be treated with water to degermanate at least a portion of the molecular sieve to produce a phyllosilicate.

Preferably, the water does not contain an inorganic acid, an organic acid, or a salt thereof. Examples of inorganic acids include hydrochloric acid, nitric acid, sulfuric acid and phosphoric acid. Examples of organic acids include oxalic acid, formic acid, acetic acid, and propionic acid. Preferably, the water does not contain an inorganic base, an organic base, or a salt thereof. Examples of inorganic bases include ammonia and alkali or alkaline earth metal hydroxides and carbonates. Examples of organic bases include organic amines. Using water for degermanation is important because acids or bases can dealuminate the CIT-13 molecular sieve, which can negatively impact the active catalytic features of the resulting product.

The resulting phyllosilicate may be described as a two-dimensional material comprising silicon-rich cfi-layers resulting from the delamination of CIT-13, in which the germanium-rich d4r units are removed by hydrolysis, with the corresponding introduction of surface silanol (Si—OH) groups. The resulting phyllosilicates may also be described as aluminogermanosilicate compositions consisting essentially of siloxylated silicon-rich cfi-layers (of the CIT-13 framework). Without intending to be bound by any theory, it is believed that the transformations described herein generally retain the structure of these silicon-rich cfi-layers, and the starting material and final product differ in the ways in which these silicon-rich cfi-layers are joined with one another.

These phyllosilicates may be characterized by a major peak in the powder XRD pattern in a range of from about 6.9 to about 9 degrees 2-theta, such as from 7.0 (±0.2) to 8.1 (±0.2) degrees 2-theta. This major peak is at a higher angle than the corresponding major peak in the Al-CIT-13 molecular sieve from which it is derived. This shift to higher 2-theta angles in the phyllosilicate is consistent with the removal of the d4r building units and the closer pack stacking of the silicon-rich cfi-layers. Some variance may be seen in the absolute position of this major peak. This can be explained when one appreciates that the peak is attributable to stacked individual layers (i.e., each layer is insufficient to provide a diffraction pattern) and it is only by stacking multiple phyllosilicate layers that a diffraction pattern can be seen. In this case, the stacking appears to be extremely sensitive to trace intercalant impurities (e.g., water) which may exist between phyllosilicate layers, which influences the packing and therefore the location of the diffraction peak. Additionally or alternatively, different levels of silanol pendants may affect the stacking distances. In any case, the d-spacing of the stacked layers is in a range of from 10.5 Å0 to 11.5 Å.

The phyllosilicate can have a SiO₂/GeO₂ molar ratio of at least 25 (e.g., 25 to 200, or 25 to 100, or 25 to 80, or 25 to 60, or 50 to 200, or 50 to 100, or 50 to 80, or 50 to 60). Additionally or alternatively, the phyllosilicate may have a SiO₂/Al₂O₃ molar ratio of at least 50 (e.g., 50 to 1000, or 50 to 800, or 100 to 1000, or 100 to 800, or 200 to 1000, or 225 to 800).

The Al-CIT-13 molecular sieve may be treated with water at a temperature in a range of from about 20° C. to 180° C. (e.g., 50° C. to 100° C., or 60° C. to 100° C., or 70° C. to 100° C., or 80° C. to 100° C., or 90° C. to 100° C.)

The Al-CIT-13 molecular sieve may be treated with water for a time in a range of from 30 minutes to 72 hours (e.g., 6 to 36 hours, or 18 to 30 hours).

The weight ratio of the water relative to Al-CIT-13 during treatment may be in a range of 2:1 to 500:1 or more (e.g., 5:1 to 500:1, or 10:1 to 500:1, or 50:1 to 500:1, 100:1 to 500, or 2:1 to 300:1, or 5:1 to 300:1, or 10:1 to 300:1, or 50:1 to 300:1, or 100:1 to 300:1).

After treating Al-CIT-13 with water, the resulting phyllosilicate may be separated from suspension. No specific restrictions exist with regard to a suitable separation method and every solid-liquid separation technique is conceivable. Suitable separation methods include filtration such as suction or pressure filtration, centrifugation, and rapid drying such as spray-drying or spray-granulation.

The recovered phyllosilicate can be subjected to a washing step and/or drying.

Any conceivable washing agent can be used. Washing agents which may be used include water, alcohols (e.g., methanol, ethanol, propanol), or mixtures thereof. Water or a mixture of water and at least one alcohol, preferably water and ethanol, is preferred, with water being particularly preferred as the washing agent. If washing is applied, it is preferred to continue the washing process until the washing water has a conductivity of at most 1000 μS/cm (e.g., at most 850 μS/cm, or at most 700 μS/cm).

Suitable drying methods include conventional drying in an oven, either as batch or continuous drying process, rapid-drying such as spray-drying or spray-granulation, flash drying, or microwave drying. The drying may be carried out at a temperature in the range of from about 20° C. to 200° C. (e.g., 80° C. to 190° C., or 100° C. to 180° C.) in a suitable atmosphere such as technical nitrogen, air, lean air, or vacuum.

The phyllosilicates are capable of topotactic rearrangements [(re)organizing and (re)assembling] to form CIT-15.

After treating Al-CIT-13 with water, the resulting phyllosilicate is subjected to calcination. Upon calcination, the phyllosilicate can undergo topotactic rearrangements to form aluminogermanosilicate CIT-15 molecular sieve.

Topotactic rearrangements can occur with layered materials that contain terminal silanol groups, such as the presently produced phyllosilicate. With calcination, these terminal silanol groups condense, releasing water and forming Si—O—Si bonds. Without intending to be bound by any theory, the conversion of the phyllosilicate to CIT-15 is believed to be operating by this mechanism.

The calcining step may be conducted at a variety of temperatures and time periods. Typical peak calcining temperatures often fall within a range of from 350° C. to 925° C. or more (e.g., 400° C. to 650° C.)

The calcining step may be conducted in a time period that may be in a range of from 30 minutes to 48 hours (e.g., 1 to 24 hours, or 1 to 12 hours, or 2 to 10 hours, or 3 to 8 hours, or 4 to 6 hours).

The calcining step may be conducted in a calcining gas stream that comprises an inert gas (e.g., nitrogen), oxygen, air, or any mixture or combination thereof. In some aspects, the calcining gas stream may comprise air, while in other aspects, the calcining gas stream may comprise a mixture of air and nitrogen. Yet, in certain aspects, the calcining gas stream may be an inert gas, such as nitrogen and/or argon.

The calcining step may be carried out in any number of well-known devices including rotary calciners, fluid bed calciners, batch ovens, and the like.

As taught by U.S. Patent Appl. Pub. No. 2017/0252729, molecular sieve CIT-15 may be described as having a powder XRD pattern exhibiting at least five of the characteristic peaks at 8.15 (±0.2), 10.13 (±0.2), 12.80 (±0.2), 16.25 (±0.2), 19.03 (±0.2), 19.97 (±0.2), 20.33 (±0.2), 23.79 (±0.2), 23.91 (±0.2), 24.10 (±0.2), 24.63 (±0.2), 25.77 (±0.2), 26.41(±0.2), 27.75 (±0.2), 34.7 (±0.2), and 37.78 (±0.2) degrees 2-theta. In separate embodiment, the molecular sieve may exhibit six, seven, eight, nine, or ten of these characteristic peaks.

The present Al-CIT-15 molecular sieve may have a SiO₂/GeO₂ molar ratio, of at least 25 (e.g., 25 to 100, or 25 to 80, or 25 to 60, or 40 to 100, or 40 to 80, or 40 to 60). Additionally or alternatively, the Al-CIT-15 molecular sieve may have a SiO₂/Al₂O₃ molar ratio of at least 50 (e.g., 50 to 500, or 50 to 200, or 100 to 500, or 100 to 200).

### EXAMPLES

The following illustrative examples are intended to be non-limiting.

### Example 1

### Synthesis of Al-CIT-13

9.9 g of 1,2-dimethyl-3-(3-methylbenzyl)imidazolium hydroxide (Q-OH) solution (19.4% solution) was added to a 23 mL Teflon liner. 0.37 g germanium oxide was added and the mixture was stirred until clear. 2.75 g of a NALCO Water aluminosilicate sol (SAR=131; 31.2% silica-alumina solids in water) was added. Excess water was evaporated by gently blowing a stream of nitrogen over the top of the liner, and the water content was adjusted appropriately. Then, 0.37 g of hydrofluoric acid (48%) was added. Finally, 0.03 g of germanosilicate CIT-13 seeds were added.

The final molar ratio of the gel was as follows: 1 SiO₂:0.0076 Al₂O₃:0.25 GeO₂:0.625 Q-OH:0.625 HF:12.5 H₂O.

The liner was transferred to a stainless steel autoclave, and the autoclave was placed into a 160° C. oven and rotated at 43 rpm for 14 days. The solid product was washed with excess deionized water and dried in a 95° C. oven.

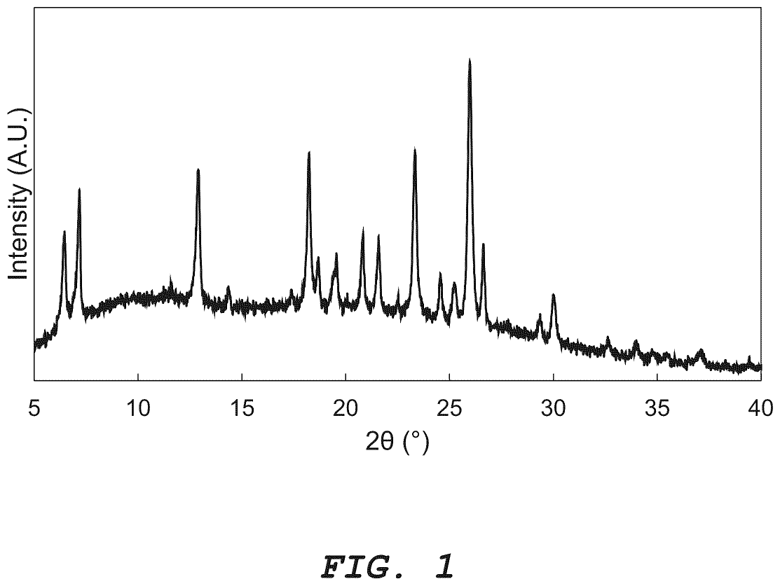

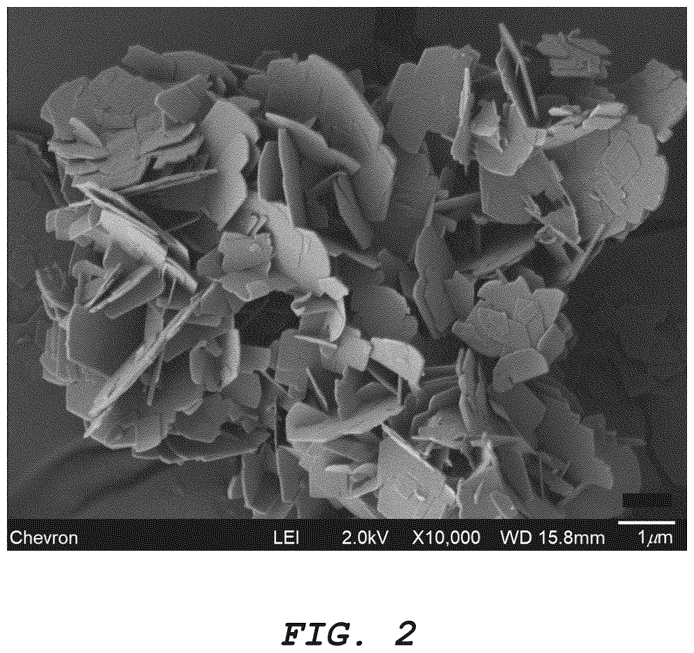

The dried product was analyzed by powder XRD and SEM. A powder X-ray diffraction pattern of the product is shown in FIG. 1 and indicates that the product comprises pure phase CIT-13. A SEM image is depicted in FIG. 2 and shows a uniform field of crystals.

The as-synthesized product had a SiO₂/Al₂O₃ molar ratio of 130 and a SiO₂/GeO₂ molar ratio of 5, as determined by Inductively Coupled Plasma-Atomic Emission Spectroscopy (ICP-AES).

### Example 2

### Calcination of Al-CIT-13

The as-synthesized product of Example 1 was calcined inside a muffle furnace under a flow of air heated to 550° C. at a rate of 1° C./minute and held at 550° C. for 5 hours, cooled and then analyzed by powder XRD. The powder XRD pattern indicated that the material remained stable after calcination.

The calcined product had a SiO₂/Al₂O₃ molar ratio of 133 and a SiO₂/GeO₂ molar ratio of 5, as determined by ICP-AES.

The calcined product was subjected to a micropore volume analysis using N₂ as adsorbate and the t-plot method. The material exhibited a micropore volume of 0.15 cm³/g.

### Example 3

### Synthesis of Al-CIT-13

8.35 g of 1,2-dimethyl-3-(3-methylbenzyl)imidazolium hydroxide (Q-OH) solution (19.4 wt. %) was added to a 23 mL Teflon® liner followed by 0.31 g of germanium oxide, and the mixture was stirred until clear. Then, 0.05 g of aluminum isopropoxide followed by 2.50 g of tetraethyl orthosilicate were added. The appropriate amount of ethanol, isopropanol, and water were evaporated by gently blowing a stream of nitrogen over the top of the liner. When the correct molar ratio was achieved, 0.31 g of HF (48 wt. % solution) was added, and the mixture was homogenized with a spatula. Then, 0.02 g of germanosilicate CIT-13 seeds were added and the mixture was homogenized with a spatula. The molar ratio of the gel was 1 SiO₂:0.01 Al₂O₃:0.25 GeO₂:0.625 Q-OH:0.625 HF:12.5 H₂O.

The liner was then loaded into a stainless steel autoclave and synthesized in a 160° C. oven with rotation at 43 rpm for 14 days. The solid product was washed with excess deionized water and dried in a 95° C. oven.

The recovered product was identified to be CIT-13 by powder XRD.

### Example 4

### Synthesis of Al-CIT-13

9.09 g of 1,2-dimethyl-3-(3-methylbenzyl)imidazolium hydroxide (Q-OH) solution (19.4 wt. %) was added to a 23 mL Teflon® liner followed by 0.34 g of germanium oxide, and the mixture was stirred until clear. Then, 0.04 g of Reheis F2000 aluminum hydroxide (50% Al₂O₃) followed by 2.75 g of tetraethyl orthosilicate were added. The appropriate amounts of ethanol and water were evaporated by gently blowing a stream of nitrogen over the top of the liner. When the correct molar ratio was achieved, 0.34 g of HF (48 wt. % solution) was added, and the mixture was homogenized with a spatula. Then, 0.02 g germanosilicate CIT-13 seeds were added and the mixture was homogenized with a spatula. The molar ratio of the gel was 1 SiO₂:0.01 Al₂O₃:0.25 GeO₂:0.625 Q-OH:0.625 HF 12.5 H₂O.

The liner was then loaded into a stainless steel autoclave and synthesized in a 160° C. oven with rotation at 43 rpm for 14 days. The solid product was washed with excess water and dried in a 95° C. oven.

The recovered product was identified to be CIT-13 by powder XRD.

### Example 5

### Synthesis of Al-CIT-15

0.1 g of the calcined Al-CIT-13 sample from Example 2 was added to 25 g of deionized water in a Teflon-lined FEP bottle. A magnetic stirring bar was added and the mixture was stirred in a 95° C. oil bath for 24 hours. The mixture was then centrifuged at 15,000 rpm and the liquid was decanted. The solid product was dried at room temperature in a vacuum oven overnight.

The dried product was then calcined as in Example 2.

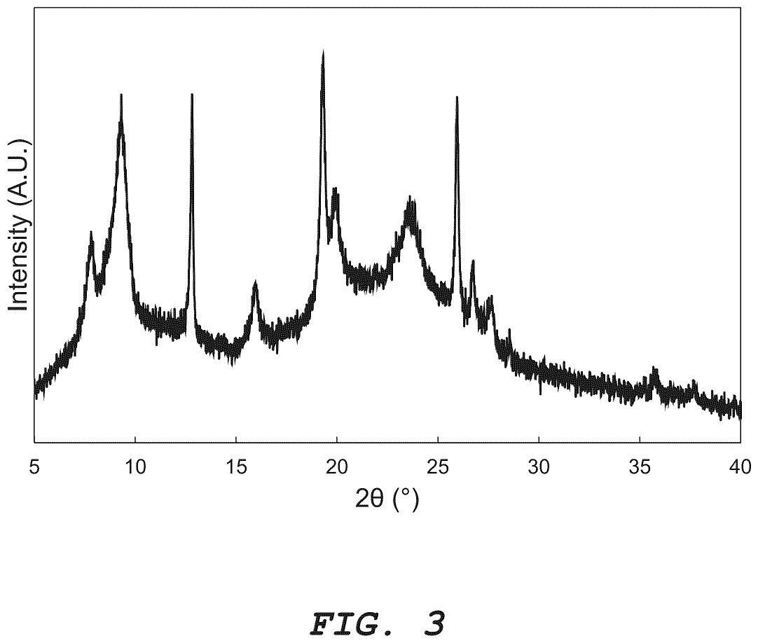

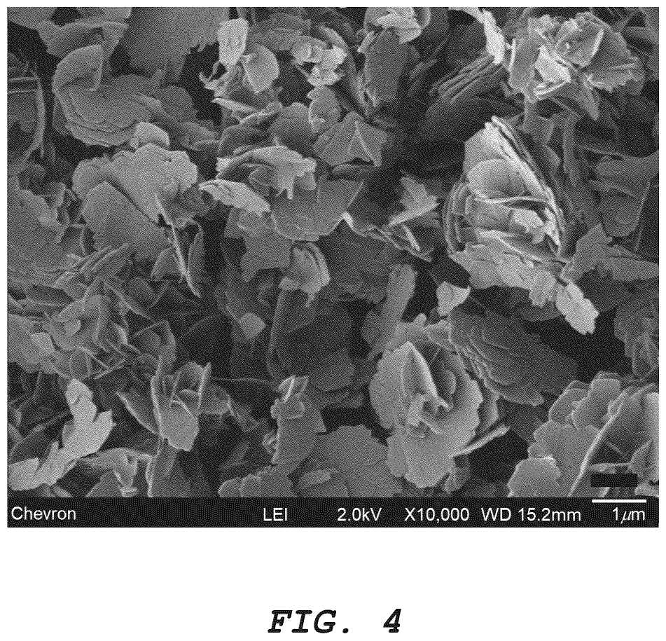

The calcined product was analyzed by powder XRD and SEM. A powder X-ray diffraction pattern of the product is shown in FIG. 3 and indicates that the product comprises pure phase CIT-15. A SEM image is depicted in FIG. 4 and shows a uniform field of crystals.

The calcined product had a SiO₂/Al₂O₃ molar ratio of 132 and a SiO₂/GeO₂ molar ratio of 51, as determined by ICP-AES.

The calcined product was subjected to a micropore volume analysis using N₂ as adsorbate and the t-plot method. The molecular sieve exhibited a micropore volume of 0.03 cm²/g.

The acid site density of the calcined product was characterized by temperature-programmed desorption using n-propylamine and found to be 28 μmol H⁺/g.

### Example 6

### Catalyst Preparation

Al-CIT-15, prepared according to Example 5, was ion-exchanged in an aqueous palladium nitrate solution at a pH of about 10 and at a Pd loading of 0.5 wt. %. The Pd-exchanged zeolite was washed with deionized water to a conductivity of less than 50 μS/cm and dried. The zeolite was then calcined in air at 482° C. for 3 hours.

### Example 7

### Hydroconversion of n-Decane

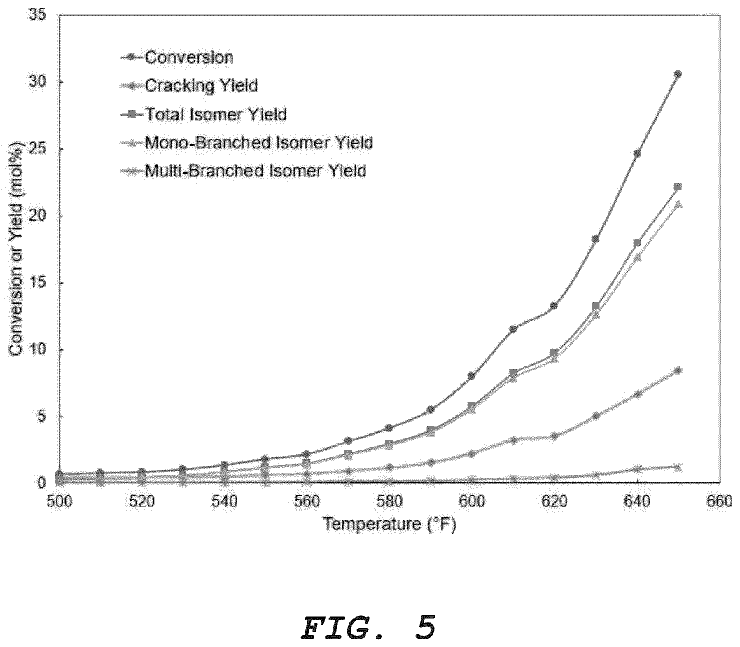

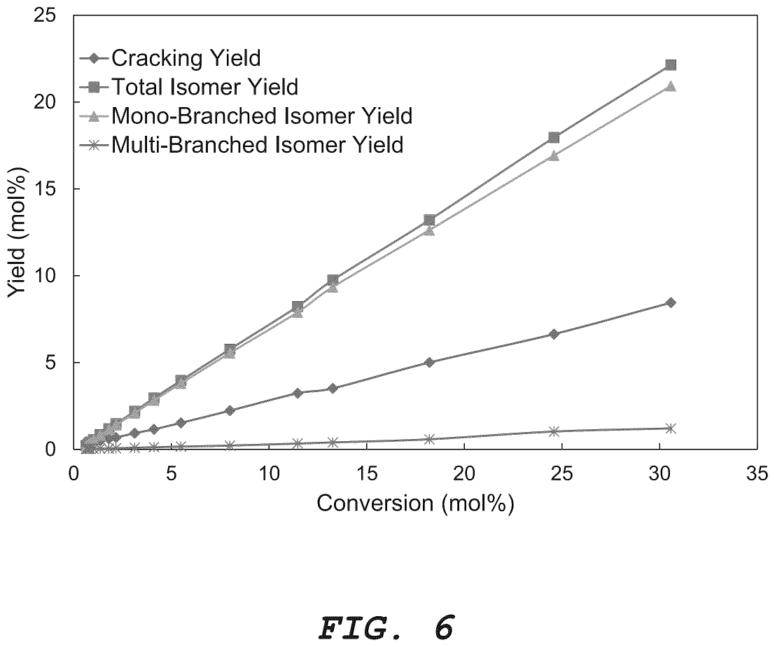

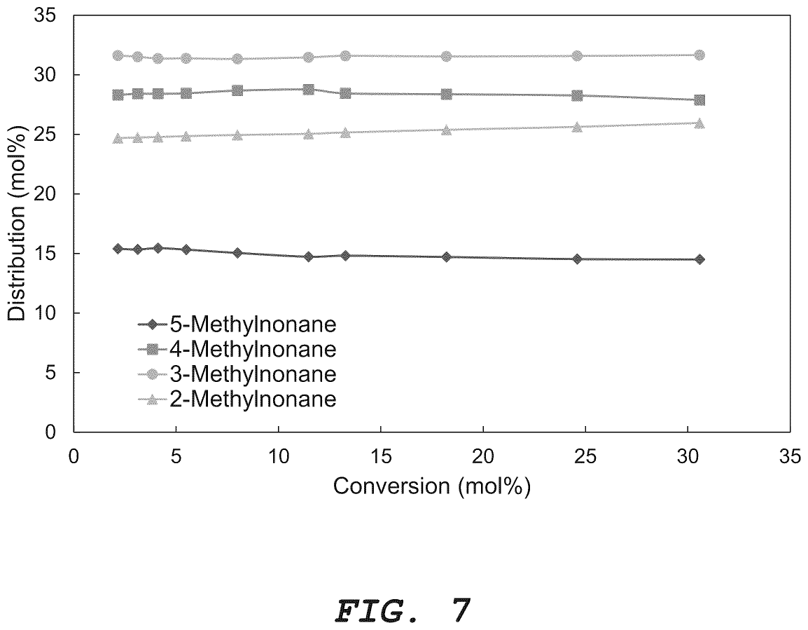

For catalytic testing, 0.5 g of the Pd catalyst of Example 6 (weight of the dehydrated sample as determined by thermogravimetric analysis at 600° C.) was loaded in the center of a 23 inch-long×0.25 inch outside diameter stainless steel reactor tube with alundum loaded upstream of the catalyst for preheating the feed (a total pressure of 1200 psig; a down-flow hydrogen rate of 12.5 mL/min, when measured at 1 atmosphere pressure and 25° C.; and a down-flow liquid feed rate of 1 mL/h). The catalyst was first reduced in flowing hydrogen at 315° C. for 1 hour. The reaction was carried out at a temperature of from 500° F. to 650° F. Products were analyzed by on-line capillary gas chromatography (GC) approximately once every sixty minutes. Raw data from the GC was collected by an automated data collection/processing system and hydrocarbon conversions were calculated from the raw data. Conversion is defined as the amount n-decane reacted in mol % to produce other products (including iso-C10). The yield of iso-C10 is expressed as mole percent of products other than n-decane. The yield of cracking products (smaller than C10) is expressed as mole percent of n-decane converted to cracking products. The results are shown in FIGS. 5-7. The results show that Al-CIT-15 performs well for isomerization.

1. A method for synthesizing aluminogermanosilicate molecular sieve CIT-13, the method comprising:
(1) preparing a reaction mixture comprising:
(a) a source of aluminum;
(b) a source of silicon;
(c) a source of germanium;
(d) an organic structure directing agent (Q) comprising one or more of 1,2-dimethyl-3-(3-methylbenzyl)imidazolium cations, 1-methyl-3-(3-methylbenzyl)-imidazolium cations, 1,2-dimethyl-3-(3,5-dimethylbenzyl)imidazolium cations, and 1-methyl-3-(3,5-dimethylbenzyl)-imidazolium cations;
(e) a source of fluoride ions;
(f) water; and
(g) seed material, wherein the seed material comprises a crystalline molecular sieve of *CTH framework type; and
(2) subjecting the reaction mixture to crystallization conditions sufficient to form crystals of the aluminogermanosilicate molecular sieve.

2. The process of claim 1, wherein the reaction mixture has a composition, in terms of molar ratios, as follows:

| | |
|---|---|
| (SiO₂ + GeO₂)/Al₂O₃ | 35 to 500 |
| Q/(SiO₂ + GeO₂) | 0.20 to 0.75 |
| F/(SiO₂ + GeO₂) | 0.20 to 0.75 |
| H₂O/(SiO₂ + GeO₂) | 5 to 20. |

3. The process of claim 1, wherein the reaction mixture has a composition, in terms of molar ratios, as follows:

| | |
|---|---|
| (SiO₂ + GeO₂)/Al₂O₃ | 50 to 165 |
| Q/(SiO₂ + GeO₂) | 0.25 to 0.65 |
| F/(SiO₂ + GeO₂) | 0.25 to 0.65 |
| H₂O/(SiO₂ + GeO₂) | 5 to 15. |

4. The method of claim 1, wherein the source of aluminum is selected from the group consisting of hydrated alumina, aluminum hydroxide, alkali metal aluminates, aluminum alkoxides, and water-soluble aluminum salts, and any combination thereof.

5. The method of claim 1, wherein the source of silicon is selected from the group consisting of colloidal silica, fumed silica, tetraalkyl orthosilicates, alkali metal silicates, precipitated silica, and any combination thereof.

6. The method of claim 1, wherein the source of both aluminum and silicon is an aluminosilicate sol.

7. The method of claim 1, wherein the source of germanium is selected from the group consisting of germanium oxide, germanium nitrate, tetraalkoxy germanium compounds, and any combination thereof.

8. The method of claim 1, wherein the source of silicon and the source of germanium are present in a molar ratio of SiO₂/GeO₂ in a range of from 1 to 10.

9. The method of claim 1, wherein the seed material comprises a molecular sieve selected from the group consisting of CIT-13, NUD-2, SAZ-1, and any combination thereof.

10. The method of claim 1, wherein the seed material is present in an amount of from 0.1 to 10% of the weight of silica in the reaction mixture.

11. The method of claim 1, wherein the crystallization conditions comprise a temperature of from 100° C. to 200° C., and a crystallization time of from about 1 day to 21 days.

12. A method for synthesizing aluminogermanosilicate molecular sieve CIT-15, the method comprising the steps of:
(1) preparing a reaction mixture comprising:
(a) a source of aluminum;
(b) a source of silicon;
(c) a source of germanium;
(d) an organic structure directing agent (Q) comprising one or more of 1,2-dimethyl-3-(3-methylbenzyl)imidazolium cations, 1-methyl-3-(3-methylbenzyl)-imidazolium cations, 1,2-dimethyl-3-(3,5-dimethylbenzyl)imidazolium cations, and 1-methyl-3-(3,5-dimethylbenzyl)-imidazolium cations;
(e) a source of fluoride ions;
(f) water; and
(g) seed material, wherein the seed material comprises a crystalline molecular sieve of *CTH framework type;
(2) subjecting the reaction mixture to crystallization conditions sufficient to form crystals of the aluminogermanosilicate molecular sieve;
(3) recovering and calcining the product of step (2) to obtain a calcined aluminogermanosilicate CIT-13 molecular sieve;
(4) treating the calcined aluminogermanosilicate CIT-13 molecular sieve with water under conditions sufficient to degermanate at least a portion of the calcined aluminogermanosilicate CIT-13 molecular sieve to provide a phyllosilicate comprising delaminated cfi-layers; and
(5) recovering and calcining the phyllosilicate under conditions sufficient to convert the phyllosilicate to an aluminogermanosilicate CIT-15 molecular sieve.

13. The method of claim 12, wherein the treating according to step (4) is carried out at a temperature of from 50° C. to 180° C.

14. The method of claim 12, wherein the treating according to step (4) is carried out for a time of from 30 minutes to 72 hours.
